(19) United States
(12) Patent Application Publication
(10) Pub. No.: US 2018/0264356 A1
(43) Pub. Date: Sep. 20, 2018

(54) ROBOTIC PINBALL GAME

(71) Applicant: Kenneth C. MILLER, Aptos, CA (US)

(72) Inventor: Kenneth C. MILLER, Aptos, CA (US)

(21) Appl. No.: 15/547,624

(22) PCT Filed: Feb. 1, 2016
(86) PCT No.: PCT/US2016/015997

§ 371 Date: Jul. 31, 2017

Related U.S. Application Data
(60) Provisional application No. 62/109,847, filed on Jan. 30, 2015.

(51) Int. Cl. A63F 13/24; A63F 13/28; A63F 13/352; A63F 13/65; A63F 13/86

(52) U.S. Cl. CPC A63F 13/24; A63F 13/28; A63F 13/213; A63F 13/65; A63F 13/86; A63F 13/352

(57) ABSTRACT

A device and process for playing a robotic pinball game is provided that includes positioning at least one robot in a space defined by at least one floor surface and walls which form a bounded play area. Moving one target around the bounded play area with at least one robot and scoring at least one robot as to moving at least one target around the bounded play area. The robotic pinball game can be wirelessly controlled with a smartphone or tablet.

### RELATED APPLICATIONS

This application is a non-provisional application that claims priority benefit of U.S. Provisional Application Ser. No. 62/109,847 filed Jan. 30, 2015; the contents of which are hereby incorporated by reference.

### FIELD OF THE INVENTION

The present invention in general relates to entertainment and games, and in particular to a robotic pinball game for the general public.

### BACKGROUND OF THE INVENTION

Most robot games are intended for the robots to push each other around (sumo), destroy each other (e.g., BattleBots, RoboWars, etc.), or play some form of soccer (push/roll/kick a ball into a goal outside the game area that can be visited by the robot). In addition, some robot games are designed for a specific purpose for hobbyists and educational competitions (e.g., First, etc.).

Separately, most pinball games are designed for use with paddles intended to keep a pinball in play. The objective of most pinball games is to use paddles to aim a pinball at various targets, objectives and obstacles located at various positions around the play area. The more targets, objectives and obstacles the pinball hits, and the longer the pinball is kept in the play area, the higher the score being generated. However, there are currently no pinball games using robots to push targets around a play area hitting, touching and approaching target objectives, and to fire projectiles at projectile targets to generate scoring. As a result, pinball games have been designed with ever greater levels of complexity and gimmicks in an attempt to add excitement to the basic process of striking a rolling ball repetitively with a paddle.

In a similar game played on a flat surface, competing robots are used to score points by pushing or knocking robots or robot targets such as balls, pucks, blocks, etc. through openings (gates or goals) outside of a play area. Exemplary of these gaming systems is US 2014/0100012. However, there are currently no pinball games using robots to keep targets within a play area to generate scoring.

Thus, there exists a need for robotic game to add new found complexity and skill development to a pinball like game. There also exists a need for a process for playing a robot pinball game for the general public.

### SUMMARY OF THE INVENTION

A robotic pinball game device and process for playing a robotic pinball game is provided. A process for playing a robotic pinball game includes positioning at least one robot in a bounded play area defined by at least one floor surface and walls. At least one target is moved around the play area by a robot. The robot moves the target around the play area hitting, touching and approaching target objectives generating scoring. At least one robot is controlled by a player to navigate the robot within the playing surface and manipulate at least one target towards a target objective. The robot may be controlled wirelessly using a smartphone or tablet. A projectile launcher that shoots projectiles at at least one projectile objective generating scoring may be mounted to at least one robot. At least robot objective may be positioned within the play area. Machine readable markings may be embedded onto at least one robot, one target, one projectile, one target objective, one robot objective and one projectile objective. A vision system for recognizing machine readable markings may be mounted at positions around or on top of the playing area. A vision system may alternatively be mounted to at least one robot, one target, one target objective, one robot objective and one projectile objective. A logic board for simultaneously coordinating the elements of the robotic pinball game may be provided. The logic board may also generate and transmit real-time game data including scoring.

A robotic pinball game device includes at least one floor surface and walls forming a bounded play area, at least one robot, at least one target and a set of instructions for playing the robotic pinball game. The robotic pinball game also optionally includes a projectile launcher, at least one projectile, target objective, projectile objective, robot objective, dual axis XY-Linear Motor for controlling, collecting, moving and automatically resetting the position of the robot within the dynamic play area, speakers for projecting audio, a vision system for recognizing machine readable markings located on at least one robot, target, projectile, target objective, projectile objective, or robot objective and for identifying, tracking, locating and monitoring the locations of and interactions between the game elements, and a logic board for simultaneously coordinating the game elements and generating and transmitting real time game data including scoring. A controller is assigned to each player for interactive control of an assigned robot. The controller may be a smartphone or tablet that controls a robot wirelessly. The game elements may be of different sizes, shapes and colors. A plurality of floor surfaces may be provided, some of which are movable. Some floor surfaces may be microporous to allow for the flow-through of compressed air. The game concludes when all of the targets have been eliminated from the playing surface. The player with the highest score or shortest time to complete a predefined task wins.

### BRIEF DESCRIPTION OF THE DRAWINGS

The present invention is further illustrated with respect to the following FIGURE. This FIGURE in not intended to limit the scope of the appended claims only to those aspects depicted in the FIGURE, but instead to illustrate one specific operative embodiment to the invention.

FIG. 1 is a top down view of an inventive robotic pinball game device with wirelessly connected controller.

### DETAILED DESCRIPTION OF THE INVENTION

The present invention has utility as a robotic pinball game device and a process for playing and scoring a robotic pinball game that integrates the functions of robots with portable electronics, such as smart phones or tablets. The game can be played simultaneously with multiple: robots, targets, objectives, players or smartphones to control the game. A robot is designed to push a target around a play area, or touching, or hitting or approaching objectives to generate scoring. The robots are also designed to fire projectiles at projectile targets generating scoring. The longer the targets remain in the play area, and the more objectives and projectile targets the projectiles and targets touch, hit and approach, the higher the score generated. The objective of the game is to generate the highest score possible or complete a set of tasks in the shortest possible time.

As used herein, a robotic pinball game is intended to define a novel process of game play and a game system that uses at least one robot operating within a game area to direct a game element within the game area to complete game objective to score points or complete a task based on the model of a conventional pinball game. It is appreciated that in contrast to a conventional pinball game that relies on gravity to move a ball towards fixed paddles that upon hitting the ball urge it into contact with various bumpers and targets, with resort to a user controlled robot, gravity optionally can be used to

[symbol]

In a first embodiment of the inventive process for playing a robotic pinball game at least one robot is positioned within a space defined by at least one floor surface and walls which form a bounded play area. At least one target is moved around the bounded play area with the robot. Scoring is generated as to moving the robot and the target around the bounded play area. A projectile launcher for launching projectiles including one of at least a liquid, gas, airplane, rocket, visible light beam, infrared beam, laser beam, flame, or firework may be mounted to the robot.

A robot suitable for inventive game play and controls therefor is detailed in US 2014/0100012 generally and in particular with respect to FIGS. 7 and 8 thereof. It is appreciated that two or more robots can be positioned within the bounded play area enabling simultaneous multi-player interaction. Additionally, the target can in some embodiments either be self-propelled with an internal power supply or levitated by air thereby eliminating the gravity powered aspects of conventional pinball. In still other embodiments, the target has controls to allow another player to actively maneuver the target thereby rendering it as a robotic target to add a chase aspect between the robot and the target, in comparison to powered, but random moving target. Ideally, a robot used in the inventive game is wirelessly controlled with a controller. The controller can be a devoted or controller or be a smartphone or tablet running a software app control program.

In instances where the inventive process for playing robotic pinball game includes utilization of multiple robots, the robots themselves may be configured with sensors for tracking when a specific robot hits a particular target or targets, launches a scoring projectile, meets some maneuvering objective, contacts another robot, or otherwise generates a scoring event. It is appreciated that a scoring event can either add positive points, subtract points, accord a dead time penalty, accord a bonus play time reward, or a combination thereof. As noted above the sensor used in the robots would be operative to recognize targets, other robots, projectiles, target objectives, robot objectives, and projectile objectives with unique machine readable or recognizable electronics/components (RFID, magnets, etc.) or machine readable (vision) unique marks or colors embedded on or within each target, each robot, each projectile, each target objective, robot objective, and projectile objective.

In play, a user attempts to maneuver his/her robots to urge a target, around and through the bounded play area performing at least one of touching, hitting, approaching, or shooting at a target objective directly or by urging the target into the target objective, a projectile objective, or a robot objective. A player controlling the robot often attempts to maximize the amount of time that the robot and target are kept in play and in play modes that optimize scoring or reduce the time to complete a task. In some scoring schemes, the longer the robot and target are kept in play and the more target objectives, projectile objectives, and robot objectives the robot and target manage to touch, hit, approach, or shoot, the higher the score. The player with the highest score wins.

It is appreciated that the floor surface can be planar, contoured, of more than one surface connected with ramps or lift areas. Each floor surface can be leveled relative to the horizon or tilted to create an angled surface that gives the target a preferential direction of movement. In some inventive embodiments, the floor surface is hemispherical to afford a skilled player the ability to use parabolic target trajectories to deliver a target to a target objective, or move into scoring proximity to a target objective.

In certain embodiments of an inventive process for playing a robotic pinball game, a playing surface is a foldable mat to promote ease of storage and game mobility. A mat is in some embodiments embedded with tracking and identification sensors, the mat dimensioned to fit the perimeter boundaries of the playing area, may be used to track individual robots, targets, and projectiles. The mat may have a plain rubber or metal finish, as found on standard pinball playing surfaces, and optionally includes indicia related to a game.

A specific target objective is either stationary or mobile. A target objective can be achieved to afford points of pre-selected degrees by delivering the target thereto, moving the robot into proximity therewith, or launching a projectile into contact with the target objective. It is appreciated that a given target objective may be available for all types of scoring, or may be devoted to a specific type of scoring such as, for example, only projectile scoring or only target contact scoring; or may allow more than one type of scoring. In some inventive embodiments, a target objective is equipped with indicator lights to indicate to a user the availability of a given target objective for scoring, or a bonus/penalty relative to a default condition for engaging the target objective at a given time.

A target objective, whether stationary or mobile, in some embodiments includes a motorized gate that opens and closes thereby making the target objective only selectively available for generating additional scoring. If the robotic pinball game is being played with multiple players, the target objective also has the ability to actively identify from which robot a target or projectile was pushed or fired from for scoring purposes. Based on positional knowledge or robot position and directions of movement, vector calculation of the movement of a target, robot, or projectile are wholly conventional. For linear movement in a plane vector calculations are based on the equation y=mx+c.

In some inventive embodiments, an inventive robotic pinball game is equipped with a vision system. A vision system is illustratively mounted to a floor surface, a wall, a target objective, a robot, an overhead gantry or ceiling feature, or a combination thereof. The vision system recognizes readable markings on various game articles such as a robot, a target, a projectile, a portion of the game surface, or a combination thereof and as a result of determined the movement of various game articles, can calculate scoring. While a video vision system based on natural light provides additional capabilities, it is appreciated that LIDAR ranging and scoring detection is also operative herein, as well as simple mechanical switching for single robot play. Mechanically triggered electrical switches are conventional to existing pinball machines such as microswitches equipped with wires, rollers or levers and are found in Bally Manufacturing Corporation Model 606-1000. Alternatively, or in combination, the vision system also affords a player the ability to view the game from the video stream provided by one or more cameras of the video system. A video camera output can be used broadcasting video of the game to share game highlights, or be broadcast in real-time so the game can be played remotely, for instant replay, or a combination thereof. The vision system can track and identify game articles through techniques that illustratively include with character recognition of a character printed on each, read a unique machine readable (vision) markings or colors that are operative with the vision system, through artificial intelligence to track articles based on initial position, or a combination thereof. Markings may include colors, LIDAR coating, barcodes, quick response (QR) codes, or combinations thereof. It is appreciated that identification of game articles is also accomplished electronically with a unique machine cognizable non-visual signal associated with several game articles. Such signals are detected by sensors operative to recognize the radio frequency identification (RFID), magnet, or other electronic embedded components, may be positioned at locations within, around, below, and above the bounded playing area; or associated with a given gaming article. These sensors are operative to track, locate, and monitor the locations of and interactions between individual gaming articles such as robots, targets, projectiles, portions of the gaming surface, and target objectives.

A logic board is provided in some inventive embodiments to generate and transmit game data to a display indicating scores, other game information, and other visual graphics such as a live video feed. The logic board in some embodiments is in simultaneously communication with, and coordinates all game components and with the vision system via wireless or wired connection (Wi-Fi, Bluetooth, computer network, etc.) to control the inventive robotic pinball game.

An inventive robotic pinball game is equipped with a dual axis X-Y linear motor integrated into the bounded playing area. The dual axis X-Y linear motor moves, controls, collects, automatically resets the position of, and automatically reintroduces back into the bounded play area any of the aforementioned game articles. This is particularly advantageous when the game is played wholly by remote players.

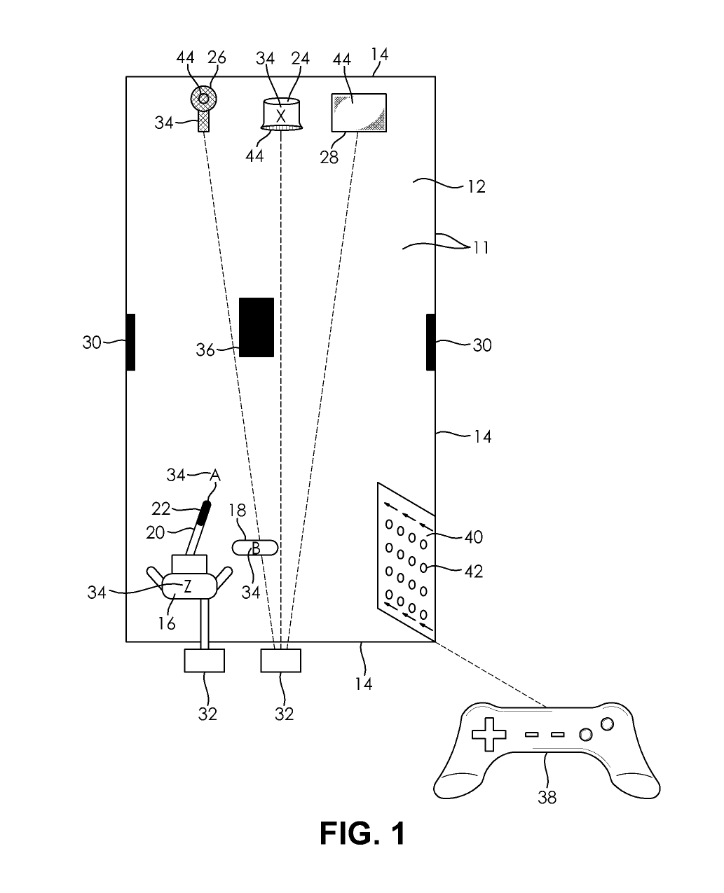

Referring now to the figures, FIG. 1 is a top down view of an inventive robotic pinball game device 10 with at least one floor surface 12 and walls 14 which form a bounded play area 11. At least one robot 16 and one target 18 are located within the bounded play area 11. A set of instructions for playing the inventive robotic pinball game (not pictured) is also provided.

An inventive robotic pinball game device is shown generally at 10 in FIG. 1 and includes a movable floor surface 40 can be provided that have an array of pores 42 in fluid communication with a source of compressed air so as to allow a game article with a suitable ratio of weight to surface area to levitate above the floor surface 40. A robot 16 is present and can include a projectile launcher 20 carries a shootable projectile 22. A movable target 18 are also provided. A target objective 24, 26, or 28 is present and as depicted are specifically a target objective 24, and a robot objective 28 positioned at a location on the bounded playing area 11. It is appreciated that a target objective can be a combination of objective-types. Each of the target objectives 24, 26, or 28 independently varies in shape, size, and color relative to others. The target objective 24, projectile objective 26, and robot objective 28 may also include a motorized gate, an indicator light, or a combination thereof 44. The instructions for playing the robotic pinball game device 10 include maneuvering a robot 16 so as to urge a target 18 within the bounded play area 11 performing at least one of touching, hitting, approaching or shooting at least one of a target objective 24, 26, or 28 to maximize score or minimize time to accomplish are particular task of keeping the target 18 in play and meeting target objectives.

At least one dual axis X-Y linear motor 30 moves, controls, collects, and automatically resets the position of a robot 16 within the bounded play area 11. Speakers 30 for projecting game sounds, notifications, music or other audio may be mounted at positions within or along the bounded play area 11. A vision system 32 for recognizing machine readable markings 34 and identifying, tracking, locating, and monitoring the locations of and interactions between a robot 16, a target 18, and a projectile 22 with a floor surface 12, walls 14, a target objective 24, a projectile objective 26, or a robot objective 28 is mounted at a position along, above, below or within the bounded playing area 11. The machine readable markings 34 being at least one of colors, barcodes, quick response (QR) codes, radio frequency identification (RFID), or other coded representations of uniqueness. A logic board 36 for actively monitoring and automatically scoring the robotic pinball game device 10 is provided. The logic board 36 generates and transmits real-time data as the robotic pinball game device 10 is being played and wirelessly communicates with a controller 38 and the vision system 32 to simultaneously coordinate all game elements to control and score the robotic pinball game device 10.

Any patents or publications mentioned in this specification are herein incorporated by reference to the same extent as if each individual publication was specifically and individually indicated to be incorporated by reference.

The foregoing description is illustrative of particular embodiments of the invention, but is not meant to be a limitation upon the practice thereof. The following claims, including all equivalents thereof, are intended to define the scope of the invention.

1. A process of playing a robotic pinball game comprising:
positioning at least one robot in a space defined by at least one floor surface and walls, wherein said at least one floor surface and said walls form a bounded play area;
moving at least one target around said bounded play area with said at least one robot; and
scoring said at least one robot as to moving said at least one target around said bounded play area.

2. The process of claim 1 wherein said at least one robot is two or more robots.

3. The process of claim 1 further comprising positioning an adjustable and movable target objective at a location within said bounded play area, said target objective generating scoring when said at least one target passes over, under, near, into or therethrough, wherein said target objective is motorized to open and close.

4. The process of claim 1 wherein said at least one floor surface is a plurality of floor surfaces and orienting at least one of said plurality of floor surfaces at an angle other than horizontal relative to said bounded play area.

5. The process of claim 1 further comprising mounting a projectile launcher onto said at least one robot and launching a projectile from said projectile launcher at or through an adjustable and movable projectile objective motorized to open and close generating scoring, said projectile objective actively identifying which of said two or more robots said projectile was fired from, said projectile including one of at least a liquid, a gas, a missile, an airplane, a rocket, a visible light beam, an infrared beam, a laser beam, a flame, or a firework.

6. The process of 1 further comprising wirelessly controlling said at least one robot with a controller.

7. The process of claim 6 wherein said wireless controlling is achieved using a smartphone or tablet.

8. The process of claim 1 further comprising maneuvering said at least one robot over, under, near, into, or through an adjustable and movable robot objective generating scoring wherein said robot objective is motorized to open and close.

9. The process of claim 1 further comprising mounting a vision system to at least one of said at least one floor surface, said walls, said target objective, said projectile objective, or said robot objective, said vision system recognizing machine readable markings on said at least one target, said at least one robot, and said projectile.

10. The process of claim 9 wherein said vision system recognizes said machine readable markings comprising at least one of colors, barcodes, quick response (QR) codes, radio frequency identification (RFID), or other coded representations of uniqueness.

11. The process of claim 10 wherein said vision system identifies and tracks locations of and interactions between said at least one robot, said at least one target, and said projectile relative to locations of said at least one floor surface, said walls, said target objective, said projectile objective, and said robot objective generating scoring.

12. The process of claim 1 further comprising integrating into said bounded play area at least one dual axis X-Y Linear Motor for moving, controlling, collecting, automatically resetting the position of, and automatically reintroducing back into said bounded play area said at least one robot, said at least one target, or said projectile.

13. The process of claim 1 further comprising actively monitoring the robotic pinball game using a logic board, said logic board generating and transmitting real-time data to a display indicating scores, other game information, and other visual graphics including a live video feed.

14. The process of claim 13 further comprising broadcasting said live video feed via Wi-Fi connection, Bluetooth connection, or computer network connection for remote viewing on a computer, tablet or smartphone.

15. The process of claim 13 wherein said logic board coordinates said vision system, said at least one floor surface, said walls, said at least one robot, said at least one target, said projectile, said target objective, said robot objective, said projectile objective, said at least one dual axis X-Y Linear Motor, said controller, and said display to control said robotic pinball game.

16. The process of claim 1 further comprising mounting indicator lights to said target objective, said robot objective, and said projectile objective wherein said indicator lights indicate and enable the changing of scoring from positive to negative points during game play, altering the availability of said target objective, said projectile objective, and said robot objective for scoring.

17. The process of claim 1 further comprising maneuvering said at least one robot and said at least one target along, around and through said bounded play area performing at least one of touching, hitting, approaching, or shooting at least one of said target objective, said projectile objective or said robot objective and maximizing the amount of time said at least one robot and said at least one target are kept in play generating the highest scoring possible.

18. A device for playing a robotic pinball game comprising:
at least one floor surface and walls, wherein said at least one floor surface and said walls form a bounded play area;
a robot within said bounded play area;
a target within said bounded play area; and
a set of instructions for playing said robotic pinball game.

19. The device of claim 18 further comprising:
a projectile launcher;
a projectile;
a target objective;
a projectile objective;
a robot objective;
a dual axis XY-Linear Motor for moving, controlling, collecting, and automatically resetting the position of said robot within said bounded play area;
speakers for the projection of game sounds, notifications, music or other audio;
a vision system for recognizing machine readable markings and identifying, tracking, locating, and monitoring the locations of and interactions between said robot, said target, projectile with said at least one floor surface, said walls, said target objective, said projectile objective, and said robot objective wherein said machine readable markings are at least one of colors, barcodes, quick response (QR) codes, radio frequency identification (RFID), or other coded representation of uniqueness; and
a logic board for actively monitoring and automatically scoring said robotic pinball game wherein said logic board generates and transmits real-time data as said robotic pinball game is being played and wirelessly communicates with a controller and said vision system to simultaneously coordinate all game elements to control and score said robotic pinball game.

20. The device of claim 19 further comprising:
a plurality of movable floor surfaces, at least one of said plurality of movable floor surfaces further comprising micropores adapted to allow for the flow-through of compressed air;
wherein said target, said robot, said projectile, said target objective, said robot objective and said projectile objective have a machine readable marking recognizable by said vision system and are of varying sizes, shapes and colors, wherein said target objective, said robot objective and said projectile objective further comprise motorized gates that open and close; and
wherein said instructions for playing said robot pinball game include maneuvering said at least one robot and said at least one target along, around and through said bounded play area performing at least one of touching, hitting, approaching, or shooting at least one of said target objective, said projectile objective or said robot objective and maximizing the amount of time said at least one robot and said at least one target are kept in play generating the highest scoring possible.
